(19) United States
(12) Patent Application Publication
(10) Pub. No.: US 2026/0066556 A1
(43) Pub. Date: Mar. 5, 2026

(54) Electrical Terminals

(71) Applicant: Aptiv Technologies AG, Schaffhausen (CH)

(72) Inventors: Michael Messuri, Canfield, OH (US); Nicole L. Liptak, Cortland, OH (US); James Rainey, Warren, OH (US); John Morello, Warren, OH (US)

(21) Appl. No.: 18/933,583

(22) Filed: Oct. 31, 2024

Related U.S. Application Data
(60) Provisional application No. 63/687,848, filed on Aug. 28, 2024.

(51) Int. Cl. H01R 11/05

(52) U.S. Cl. CPC H01R 11/05

(57) ABSTRACT

A terminal includes a body, a first beam, and a second beam. The body includes a first portion and a second portion. The first and second portions define a gap therebetween. The first beam includes a first end and a second end opposite the first end. The first end and the second end extend from the body. The second beam includes a first end and a second end opposite the first end of the second beam. The first end of the second beam extends from the body.

### CROSS-REFERENCE TO RELATED APPLICATIONS

This application claims the benefit of U.S. Provisional Application No. 63/687,848 filed Aug. 28, 2024, the entire disclosure of which is incorporated by reference.

### FIELD

The present disclosure relates to electrical terminals and more particularly to electrical terminals that may be used in connection with vehicles.

### BACKGROUND

Modern vehicles (e.g., automobiles) rely on electrical wiring and electrical connections to facilitate communication between various electronic components within the vehicle. Connection systems (e.g., connectors and electrical contacts) play an important role in ensuring the integrity of these electrical connections and the reliability and performance of the vehicle. Conventional connection systems typically include a housing and one or more electrical contacts (e.g., terminals) designed to make contact and establish electrical pathways with electrical contacts (e.g., terminals) located in a mating connector housing.

Maintaining secure engagement between mating terminals within a connector housing helps to ensure a reliable electrical connection. Some terminals utilize a biasing mechanism to engage a mating terminal and/or components within the connector housing. While known mechanisms for securing terminals to other terminals and/or components within a connector housing have proven acceptable for their intended purpose, a continuous need for improvement remains in the pertinent art to address the challenges (e.g., terminal-to-terminal engagement force requirements, shielding requirements, snagging, etc.) associated with connection system assembly.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a terminal. The terminal includes a body, a first beam, and a second beam. The body includes a first portion and a second portion. The first and second portions define a gap therebetween. The first beam includes a first end and a second end opposite the first end. The first end and the second end extend from the body. The second beam includes a first end and a second end opposite the first end of the second beam. The first end of the second beam extends from the body.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a terminal according to the principles of the present disclosure.

FIG. 2 is a side view of the terminal of FIG. 1.

FIG. 3 is a front view of the terminal of FIG. 1.

FIG. 4 is a top view of the terminal of FIG. 1.

FIG. 5 is a perspective view of another terminal according to the principles of the present disclosure.

FIG. 6 is a side view of the terminal of FIG. 5.

FIG. 7 is a front view of the terminal of FIG. 5.

FIG. 8 is a top view of the terminal of FIG. 5.

In the drawings, reference numbers may be reused to identify similar and/or identical elements.

### DETAILED DESCRIPTION

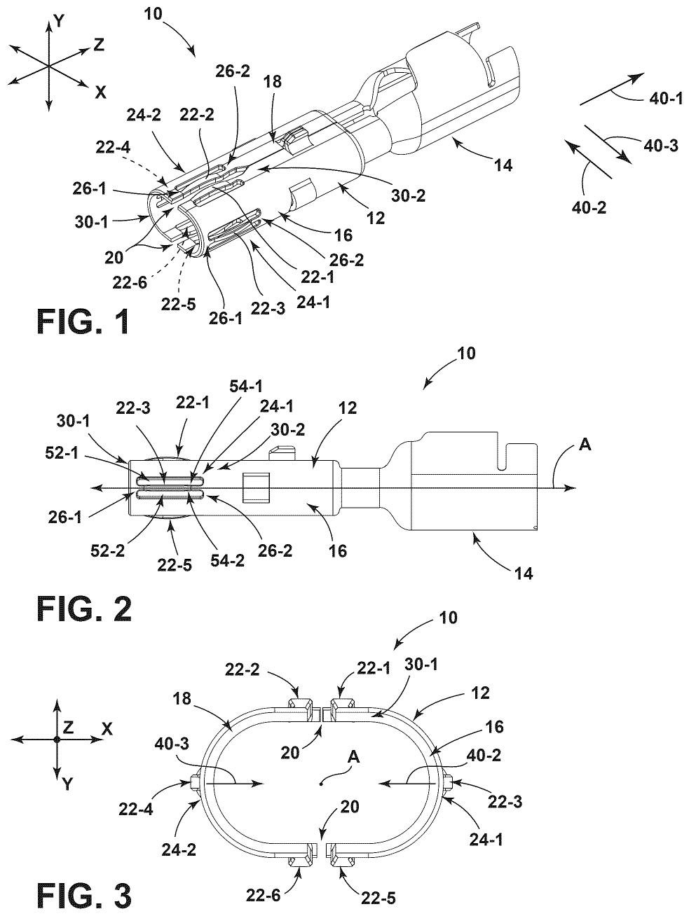

With reference to FIGS. 1-4, a terminal 10 is illustrated. The terminal 10 may include a body 12 and a conductor connection portion 14, among others. In various implementations, the body 12 includes a first portion 16 and a second portion 18. In some example configurations, the first and second portions 16, 18 define a gap 20 therebetween.

In various implementations, the terminal 10 includes a plurality of contact beams 22 coupled to the body 12. For example, the terminal 10 may include a first beam 22-1, a second beam 22-2, a third beam 22-3, a fourth beam 22-4, a fifth beam 22-5, and/or a sixth beam 22-6. While the terminal 10 is generally shown and described herein as including six beams 22, it will be appreciated that the terminal 10 may include more or less than six beams 22 within the scope of the present disclosure.

In various implementations, the first, third, and fifth beams 22-1, 22-3, 22-5 are coupled to the first portion 16 and the second, fourth, and sixth beams 22-2, 22-4, 22-6 are coupled to the second portion 18. In some example configurations, the third beam 22-3 is disposed between the first beam 22-1 and the second beam 22-2. The body 12 may include a first side 24-1 and a second side 24-2 opposite the first side 24-1. The third beam 22-3 may be disposed on the first side 24-1 and the fourth beam 22-4 may be disposed on the second side 24-2. In various implementations, the first and second beams 22-1, 22-2 define portions of the gap 20.

In various implementations, each of the beams 22 includes a first end 26-1 and second end 26-2 opposite the first end 26-1. The first and second ends 26-1, 26-2 extend from the body 12. In various implementations, the body 12 includes a front portion 30-1 and a rear portion 30-2 opposite the front portion 30-1. The first end 26-1 of a beam 22 may extend from the front portion 30-1 and the second end 26-2 of a beam 22 may extend from the rear portion 30-2. In some example configurations, the first end 26-1 is monolithically formed with the front portion 30-1 and the second end 26-2 is monolithically formed with the rear portion 30-2.

In various implementations, the gap 20 extends in a first direction 40-1 (e.g., parallel to the Z-direction) from the front portion 30-1 to the rear portion 30-2. In various implementations, the first portion 16 moves relative to the second portion 18 in a second direction 40-2 (e.g., parallel to the X-direction) traverse to the first direction 40-1. The second portion 18 moves relative to the first portion 16 in a third direction 40-3 opposite the second direction 40-2.

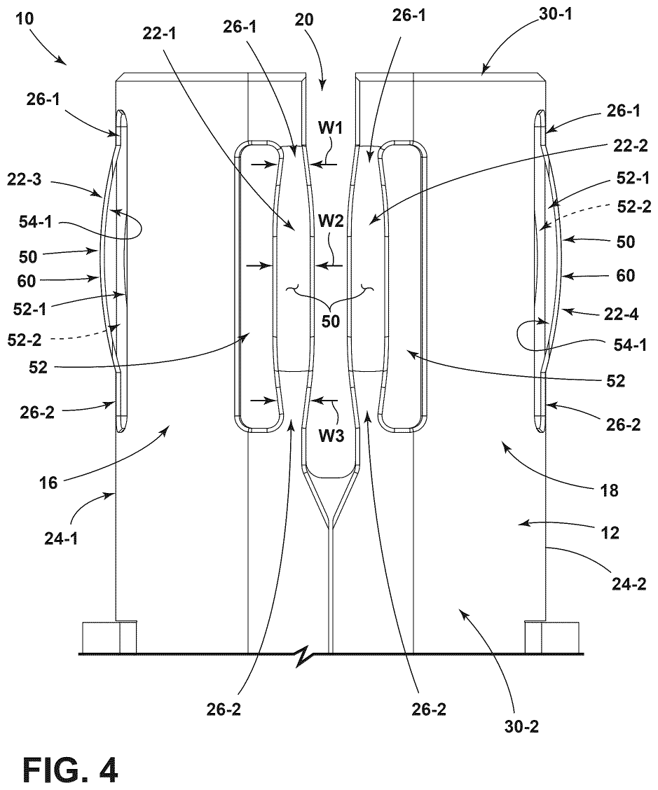

With reference to FIG. 4, in various implementations, each of the beams 22 includes a convex outer surface 50. The outer surface 50 defines a contact point for electrically connecting to a mating component (e.g., terminal). In various implementations, each of the beams 22 partially defines at least one slot 52. In some example configurations, the third beam 22-3 and the fourth beam 22-4 each partially define a first slot 52-1 and a second slot 52-2 (see, e.g., FIG. 2). In various implementations, the first slot 52-1 extends along a first side 54-1 of a beam 22-3, 22-4. The second slot 52-2 extends along a second side 54-2 of the beam 22-3, 22-4. The first side 54-1 may be opposite the second side 54-2.

With continued reference to FIG. 4, in various implementations, each of the beams 22 includes a central portion 60 disposed between the first end 26-1 and the second end 26-2. The first end 26-1 defines a first width W1. The central portion 60 defines a second width W2. The second width W2 may be greater than the first width W1. The second end 26-2 defines a third width W3. The second width W2 may be greater than the third width W3. In various implementations, the thinner portion(s) of the beams 22 (e.g., the first and second ends 26-1, 26-2) may be disposed proximate higher stress locations (e.g., ends) of the beams 22 to minimize the engage force when a contact beam 22 is deflecting (e.g., during engagement with a mating terminal). In some implementations, the first and third widths are 20-25% less than the second width W2.

Referring again to FIGS. 2 and 3, the beams 22 may be symmetrically disposed about a longitudinal axis A of the terminal 10, respectively, to symmetrically balance electro-magnetic energy distribution. The staggered arrangement of the beams 22 can further reduce the engagement force (e.g., a force required to engage the terminal 10 with a mating terminal).

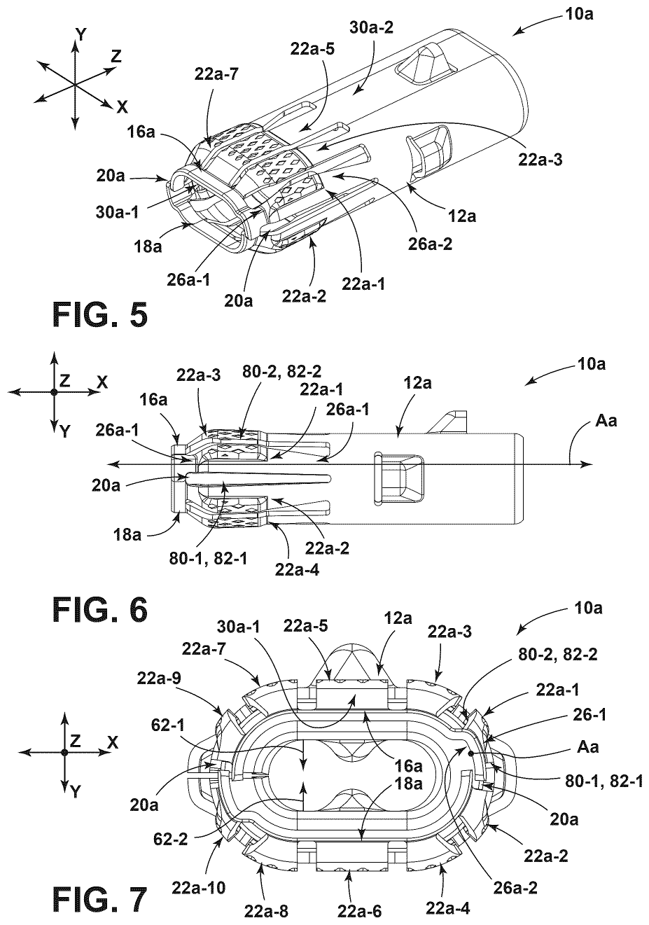

With reference to FIGS. 5-8, terminal 10a is provided. In view of the substantial similarity in structure and function of the components associated with the terminal 10a relative to the terminal 10, like reference numerals are used hereinafter and in the drawings to identify like components, and references to the terminal 10 will be understood to apply equally to the terminal 10a unless otherwise indicated.

In various implementations, the terminal 10a includes a plurality of contact beams 22a coupled to the body 12a. For example, the terminal 10a may include a first beam 22a-1, a second beam 22a-2, a third beam 22a-3, a fourth beam 22a-4, a fifth beam 22a-5, a sixth beam 22a-6, a seventh beam 22a-7, an eighth beam 22a-8, a ninth beam 22a-9, and/or a tenth beam 22a-10. While the terminal 10a is generally shown and described herein as including ten beams 22a, it will be appreciated that the terminal 10a may include more or less than ten beams 22a within the scope of the present disclosure.

In various implementations, the first, third, fifth, seventh, and ninth beams 22a-1, 22a-3, 22a-5, 22a-7, 22a-9 are coupled to the first portion 16a. The second, fourth, sixth, eighth, and tenth beams 22a-2, 22a-4, 22a-6, 22a-8, 22a-10 are coupled to the second portion 18a. In various implementations, the first portion 16a moves relative to the second portion 18a in a first direction 62-1 (e.g., parallel to the Y-direction) and the second portion 18a moves relative to the first portion 16a in a second direction 62-2 opposite the first direction 62-1 (see, e.g., FIG. 7). The first portion 16a may rotate relative to the second portion 18a. The second portion 18a may rotate relative to the first portion 16a.

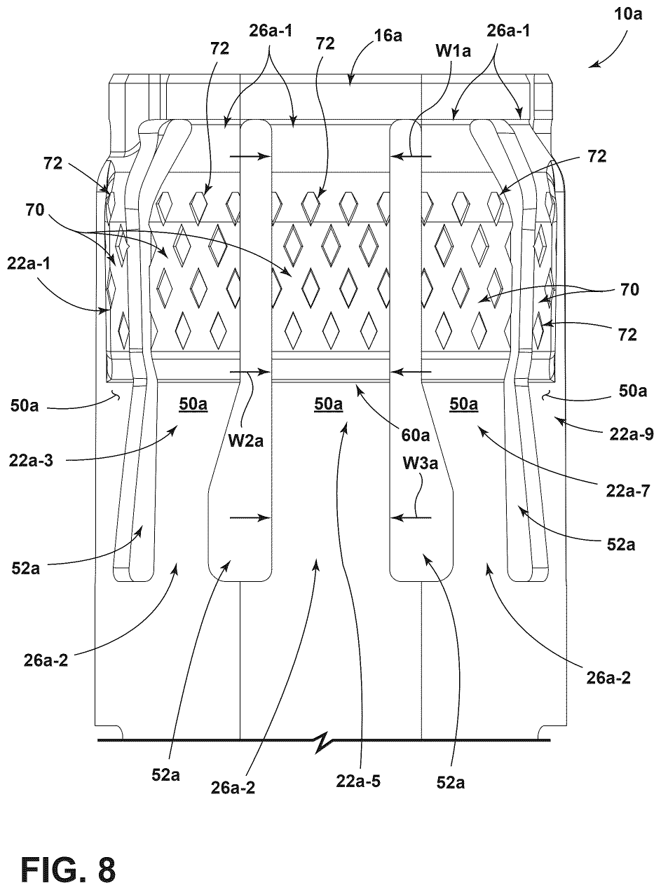

With reference to FIG. 8, the first width W1a, the second width W2a, and the width W3a of at least one beam 22a (e.g., the fifth beam 22a-5) may be identical. In various implementations, each of the beams 22a may include an outer surface 50a that has a raised portion 70. The raised portion 70 defines a contact point for electrically connecting the terminal 10a to a mating component (e.g., terminal). In some example configurations, the outer surface 50a and/or the raised portion 70 includes at least one recess 72. In some implementations, the recesses 72 further change the normal (e.g., X direction and/or Y-direction) force during engagement to a mating component (e.g., terminal).

Referring now to FIGS. 6 and 7, in various implementations, the first beam 22a-1, the second beam 22a-2, the ninth beam 22a-9, and the tenth beam 22a-10 (e.g., torsional contact arms) are incorporated at corners of the terminal 10a to flex radially allowing for decreased engage force. For example, the first beam 22a-1 defines a first longitudinal axis Aa extending between the first end 26a-1 of the first beam 22a-1 and the second end 26a-2 of the first beam 22a-1. The first beam 22a-1 rotates about the axis Aa. In some example configurations, the first beam 22a-1 includes a first edge 80-1 disposed on a first side 82-1 of the axis Aa and a second edge 80-2 disposed on a second side 82-2 of the axis Aa. The first edge 80-1 may extend linearly between the first end 26a-1 of the first beam 22a-1 and the second end 26a-2 of the first beam 22a-1. The second edge 80-2 may extend arcuately between the first end 26a-1 of the first beam 22a-1 and the second end 26a-2 of the first beam 22a-1.

Referring again to FIGS. 3 and 7, the first portion 16, 16a and the second portion 18, 18a of the body 12, 12a are configured to deflect inward during engagement to a mating component. In various implementations, the multi-action compliant design of the terminals 10, 10a incorporates a compound interaction between the inward deflection of cantilevered first and second portions 16, 16a, 18, 18a and linear and torsional deflection of lamella contacts beams 22, 22a to generate optimal compliancy.

In various implementations, the multi-action compliant design of the terminals 10, 10a can reduce the engage force and prevents yielding of individual contact beams 22, 22a. The gaps 20, 20a (e.g., longitudinal seams/slots) between the first and second portions 16, 16a, 18, 18a of the terminals 10, 10a can allow inward deflection to generate additional normal force during engagement to a mating component (e.g., terminal). The multi-action compliant design of the terminals 10, 10a may incorporate multiple independent contact points (e.g., outer surfaces 50, 50a, raised portions 70) to symmetrically balance electro-magnetic energy distribution. Further, the staggered contact points can achieve additional reduction in engagement force.

In various implementations, the location and quantity of the contact beams 22, 22a can be adjusted for design requirements. In various implementations, “Oil Can” thinning effect of the contact beams 22, 22a incorporated at higher stress locations can minimize the engage force during deflection of the contact beams 22, 22a. The contact beams 22, 22a may be attached at each end point 26-1, 26a-1, 26-2, 26a-2 thereof to prevent snagging or damage to contacts.

In an assembled configuration, the terminals 10, 10a may be mated with corresponding electrical terminals in order to transmit electricity therebetween. The terminals 10, 10a provide increased normal (e.g., Y-direction) force at one or more (e.g., each) contact point between the terminals 10, 10a and the mating terminals in order to ensure a robust electrical, mechanical, and EMC performance.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for an electrical terminal, as described above.

Clause 1: A terminal comprising: a body including a first portion and a second portion, the first and second portions defining a gap therebetween; a first beam including a first end and a second end opposite the first end, the first end and the second end extending from the body; and a second beam including a first end and a second end opposite the first end of the second beam, the first end of the second beam extending from the body.

Clause 2: The terminal of clause 1, wherein the body includes a front portion and a rear portion opposite the front portion, and wherein the first end of the first beam extends from the front portion and the second end of the first beam extends from the rear portion.

Clause 3: The terminal of clause 2, wherein: the first end of the first beam is monolithically formed with the front portion; and the second end of the first beam is monolithically formed with the rear portion.

Clause 4: The terminal of clause 2, wherein the gap extends in a first direction from the front portion to the rear portion.

Clause 5: The terminal of clause 4, wherein the first portion is configured to move relative to the second portion in a second direction transverse to the first direction.

Clause 6: The terminal of any of clauses 1 through 5, wherein the first beam includes a convex outer surface defining a contact point for electrically connecting to a mating component.

Clause 7: The terminal of any of clauses 1 through 6, wherein the first beam includes an outer surface having a raised portion defining a contact point for electrically connecting to a mating component.

Clause 8. The terminal of any of clauses 1 through 7, wherein the first beam includes an outer surface having at least one recess.

Clause 9: The terminal of any of clauses 1 through 8, wherein: the first beam includes an outer surface having a raised portion; and the raised portion includes at least one recess.

Clause 10: The terminal of any of clauses 1 through 9, wherein the first beam partially defines a first slot and a second slot.

Clause 11: The terminal of clause 10, wherein: the first slot extends along a first side of the first beam; the second slot extends along a second side of the first beam; and the first side is opposite the second side.

Clause 12: The terminal of any of clauses 1 through 11, wherein the first portion and the second portion are configured to deflect inward during engagement to a mating component.

Clause 13: The terminal of any of clauses 1 through 12, further comprising a third beam coupled to the body and disposed between the first beam and the second beam.

Clause 14: The terminal of clause 13, further comprising a fourth beam coupled to the body, wherein: the third beam is disposed on a first side of the body; and the fourth beam is disposed on a second side of the body opposite the first side.

Clause 15: The terminal of any of clauses 1 through 14, wherein the first portion includes the first beam, and wherein the first beam defines a portion of the gap.

Clause 16: The terminal of clause 15, wherein the second portion includes the second beam, and wherein the second beam defines a portion of the gap.

Clause 17: The terminal of any of clauses 1 through 16, wherein: the first beam includes a central portion disposed between the first end of the first beam and the second end of the first beam; the first end of the first beam defines a first width; the central portion defines a second width; and the second width is greater than the first width.

Clause 18: The terminal of clause 17, wherein: the second end defines a third width; and the second width is greater than the third width.

Clause 19: The terminal of any of clauses 1 through 18, wherein: the first beam defines a first longitudinal axis extending between the first end of the first beam and the second end of the first beam; and the first beam is configured to rotate about the first longitudinal axis.

Clause 20: The terminal of clause 19, wherein: the first beam includes a first edge disposed on a first side of the first longitudinal axis and a second edge disposed on a second side of the first longitudinal axis; the first edge extends linearly between the first end of the first beam and the second end of the first beam; and the second edge extends arcuately between the first end of the first beam and the second end of the first beam.

1. A terminal comprising:
a body including a first portion and a second portion, the first and second portions defining a gap therebetween;
a first beam including a first end and a second end opposite the first end, the first end and the second end extending from the body; and
a second beam including a first end and a second end opposite the first end of the second beam, the first end of the second beam extending from the body.

2. The terminal of claim 1 wherein the body includes a front portion and a rear portion opposite the front portion, and wherein the first end of the first beam extends from the front portion and the second end of the first beam extends from the rear portion.

3. The terminal of claim 2 wherein:
the first end of the first beam is monolithically formed with the front portion; and
the second end of the first beam is monolithically formed with the rear portion.

4. The terminal of claim 2 wherein the gap extends in a first direction from the front portion to the rear portion.

5. The terminal of claim 4 wherein the first portion is configured to move relative to the second portion in a second direction transverse to the first direction.

6. The terminal of claim 1 wherein the first beam includes a convex outer surface defining a contact point for electrically connecting to a mating component.

7. The terminal of claim 1 wherein the first beam includes an outer surface having a raised portion defining a contact point for electrically connecting to a mating component.

8. The terminal of claim 1 wherein the first beam includes an outer surface having at least one recess.

9. The terminal of claim 1 wherein:
the first beam includes an outer surface having a raised portion; and
the raised portion includes at least one recess.

10. The terminal of claim 1 wherein the first beam partially defines a first slot and a second slot.

11. The terminal of claim 10 wherein:
the first slot extends along a first side of the first beam;
the second slot extends along a second side of the first beam; and
the first side is opposite the second side.

12. The terminal of claim 1 wherein the first portion and the second portion are configured to deflect inward during engagement to a mating component.

13. The terminal of claim 1 further comprising a third beam coupled to the body and disposed between the first beam and the second beam.

14. The terminal of claim 13 further comprising a fourth beam coupled to the body, wherein:
the third beam is disposed on a first side of the body; and
the fourth beam is disposed on a second side of the body opposite the first side.

15. The terminal of claim 1 wherein the first portion includes the first beam, and wherein the first beam defines a portion of the gap.

16. The terminal of claim 15 wherein the second portion includes the second beam, and wherein the second beam defines a portion of the gap.

17. The terminal of claim 1 wherein:
the first beam includes a central portion disposed between the first end of the first beam and the second end of the first beam;
the first end of the first beam defines a first width;
the central portion defines a second width; and
the second width is greater than the first width.

18. The terminal of claim 17 wherein:
the second end defines a third width; and
the second width is greater than the third width.

19. The terminal of claim 1 wherein:
the first beam defines a first longitudinal axis extending between the first end of the first beam and the second end of the first beam; and
the first beam is configured to rotate about the first longitudinal axis.

20. The terminal of claim 19 wherein:
the first beam includes a first edge disposed on a first side of the first longitudinal axis and a second edge disposed on a second side of the first longitudinal axis;
the first edge extends linearly between the first end of the first beam and the second end of the first beam; and
the second edge extends arcuately between the first end of the first beam and the second end of the first beam.
